(19) United States
(12) Patent Application Publication
(10) Pub. No.: US 2021/0086540 A1
(43) Pub. Date: Mar. 25, 2021

(54) MICROEMBOSSED PRINT MEDIA

(71) Applicant: Hewlett-Packard Development Company, L.P., Spring, TX (US)

(72) Inventor: Alan Jacques, Corvallis, OR (US)

(73) Assignee: Hewlett-Packard Development Company, L.P., Spring, TX (US)

(21) Appl. No.: 17/048,211

(22) PCT Filed: Apr. 26, 2018
(86) PCT No.: PCT/US2018/029503

§ 371 Date: Oct. 16, 2020

(51) Int. Cl. B41M 5/00; B41J 11/00; G06K 15/02

(52) U.S. Cl. CPC B41M 5/0035; G06K 15/1805; G06K 15/021; B41J 11/009

(57) ABSTRACT

The present disclosure is drawn to print media. In one example, a print medium can include a print surface and a microembossed identification code applied to the print surface. The microembossed identification code can include multiple microembossed features grouped together at a location on the print surface. The microembossed features can have a feature height from 5 μm to 200 μm and can be spaced relative to adjacent microembossed features at from 20 μm to 1,000 μm.

### BACKGROUND

Digital printing methods, including ink jet printing and laser printing, have become a popular way of recording images on various media surfaces. Some of these reasons include low printer noise, variable content recording, capability of high speed recording, and multi-color recording. Additionally, these advantages can be obtained at a relatively low price to consumers. Consumer demand has led to the development of a wide variety of different print media for specialized applications. For example, available types of print media range from plain office paper, to paper having specialized ink receiving coatings, to glossy paper for posters and magazines, to transparency sheets, to fabrics, and many others.

### BRIEF DESCRIPTION OF THE DRAWINGS

FIG. 1 is a top view of an example print medium in accordance with the present disclosure;

FIGS. 2A-2B are edge views of an example print medium with a light source and a sensor in accordance with the present disclosure;

FIG. 3 is a schematic view of an example printing system in accordance with the present disclosure;

FIG. 4 is a flowchart of an example method of establishing a printer operating parameter in accordance with the present disclosure;

FIG. 5 is an example graph of voltage change from an optical sensor as the sensor moves over a microembossed feature in accordance with the present disclosure; and

FIG. 6 is an example graph of voltage change from an optical sensor as the sensor moves over a microembossed feature in accordance with the present disclosure.

### DETAILED DESCRIPTION

The present disclosure is drawn to print media that include microembossed identification codes and printing systems and methods that select an operating parameter of the printing systems based on the microembossed identification codes. In some examples, a print medium can include a print surface and a microembossed identification code applied to the print surface. The microembossed identification code can include multiple microembossed features grouped together at a location on the print surface. The microembossed features can have a feature height from 5 μm to 200 μm. These features can be spaced relative to adjacent microembossed features at from 20 μm to 1,000 μm. In certain examples, the location of the microembossed features can be within 1 cm of an edge of the print medium. In further examples, the print medium can include multiple microembossing locations. Microembossed features can occupy a first plurality of the multiple microembossing locations, and a second plurality of the multiple microembossing locations can remain as unembossed locations. The microembossed features and unembossed locations can represent a binary code. In some examples, the multiple microembossing locations can be equally spaced locations. In certain examples, the microembossed features can be microembossed linear ridges. In further examples, the microembossed features can be convex relative to the print surface.

The present disclosure also extends to printing systems. In some examples, a printing system can include a print medium and a printer. The print medium can include a print surface and a microembossed identification code on the print surface. The microembossed identification code can include multiple microembossed features grouped together at a location on the print surface. The printer can include a light source, an optical sensor, an electro-optical converter, and a controller. The light source can be directable towards the print medium at an angle of incidence when the print medium is loaded in the printer. The optical sensor can be spaced apart from the light source to optically detect reflected discontinuities from the print surface introduced by the microembossed identification code. The electro-optical converter can convert optical information related to the reflected discontinuities into electrical signal. The controller can receive the electrical signal and set an operating parameter of the printer based on the electrical signal. In certain examples, the microembossed features can have a feature height from 5 μm to 200 μm. The microembossed features can be spaced relative to adjacent microembossed features at from 20 μm to 1,000 μm. In further examples, the light source, the sensor, or both can be moveable with respect to the print medium. In still further examples, the controller can decode the microembossed identification code on the print and select the operating parameter based on the decoded microembossed identification code. In some examples, the operating parameter can include a blending ratio of multiple ink colors, a volume of ink printed per area of print medium, a printing speed, or a combination thereof. In further examples, the light source can include a visible light emitting diode, an infrared light emitting diode, a laser, a fluorescent bulb, an incandescent bulb, or a combination thereof. In still further examples, the optical sensor can include a phototransistor, a photodiode, a CMOS sensor, or a combination thereof.

The present disclosure also includes methods of establishing a printer operating parameter. In some examples, a method of establishing a printer operating parameter can include loading a print medium into a printer. The print medium can include a print surface and a microembossed identification code. The microembossed identification code can include multiple microembossed features grouped together on the print surface. The microembossed identification code can encode data representative of the print surface. Light from a light source can be directed at the microembossed identification code at an angle of incidence. The microembossed identification code can introduce discontinuities reflected from the print surface, which can be optically detected. Optical information related to the reflected discontinuities can be converted into electrical signal. An operating parameter of the printer can be selected based on information provided by the electrical signal. In some examples, the operating parameter can be related to a printing characteristic of the print surface.

In accordance with these examples, there are many applications where the technology described herein can benefit various types of users and in various circumstances. For example, rapid growth in mobile printing can produce an increased number of remote print job submissions. Many users commonly print from smartphones or other mobile devices when the users are not at the location of their printer. In some cases, a user may be unaware of the type of print media that is loaded in the printer. Without a way to check the type of media loaded in the printer, the user may face difficulties such as printing on the wrong type of paper. Even if the user is in the same location as the printer, the user may not be able to easily identify the type of media by visual inspection because many types of media, such as different types of paper, look similar to the human eye. This may result in a mismatch between the type of media in the printer and the intention of the user. For example, a user may unexpectedly print a common document, such as a recipe or email, on expensive photo paper. On the other hand, a user may wish to print a high quality photograph and accidentally print on lower quality office paper.

Additionally, various types of media can have differing optimal printing parameters. For example, media that is more absorbent may be printed at higher speeds with less drying time because ink absorbs into the media more quickly, while less absorbent media may be optimally printed at a lower print speed. Certain types of media may benefit from other printing parameters, such as volume of ink printed per unit area, or the mixing of multiple colors of ink to produce a certain visible color on the media (i.e., different color maps for different media types). Generally, it can be difficult to set printer parameters for all the various types of media because a printer may be programmed to print with a small number of printing profiles, whereas media types may have a larger variety of different optimal printing parameters. On the other hand, if printer drivers are designed to allow the user to select individual print profiles for every different type of print media, the user may be overwhelmed with the dozens or hundreds of different possible print profiles.

The present disclosure involves print media that includes microembossed identification codes. The microembossed identification codes can be read and decoded by a printer to allow the printer to automatically select optimal printing parameters for printing on the particular media type. Additionally, the microembossed identification can be relatively inconspicuous so that the appearance of the print media is not negatively affected. In some cases, the microembossed identification codes may be difficult to notice by the human eye under normal lighting conditions.

The microembossed identification codes can allow printers to automatically select operating parameters that may be more effective for the particular print media loaded in the printer. The media type may also be displayed to the user so that the user is aware of the type of media before initiating a print job. Information about the type of print media used may also be collected electronically and used to provide valuable information about end-user demographics of various media types and usage rates of different media types across different regions or demographics.

The microembossed identification codes described herein can also provide greater flexibility compared to some other print media identification methods, such as printed bar codes. When printed codes are used to identify print media, the codes are often printed on a back side of the media so that the appearance of the front side is not degraded. Thus, printing may be performed on the front side of the media but not on the back side. Such printed codes may be read by specialized sensors that are not otherwise found in printers. Other methods may attempt to identify print media type from the physical properties of the print media, such as gloss, whiteness, brightness, and so on. These methods can also use specialized sensors, and it may be very difficult to detect minute differences in these properties in similar media types. In contrast, the microembossed identification codes described herein can allow for printing on both sides of the media, and in many cases the microembossed identification codes can be read by sensors that are already included in many printers.

In some examples, the sensor used to read to the microembossed identification codes can be a light reflectance sensor already included in many printers. Some printers include such a sensor to sense paper edges and/or to measure the location of printed dots or lines on alignment test prints. The sensor may include a light emitting diode and a photo transistor receiver. These sensors may not be sufficient to identify a particular type of print media based on the surface reflectance of the medium alone. However, such a sensor can be used to detect changes in the amount light reflected back from the print medium surface due to microembossed features on the print surface. Thus, microembossed identification codes can be read by these sensors in order to identify the particular media type.

In some examples, the microembossed features can be formed by making an indentation in one face of the print medium. This can cause a convex bump or ridge to protrude from the opposite face of the print medium. The surface of the media approaching the bump or ridge can reflect light at a different angle of incidence compared to the normal, flat surface of the print medium. This can be due to the change in slope of the medium near the bump or ridge. In some examples, a light source can be spaced apart from the sensor so that light from the light source is reflected off the print surface to be detected by the sensor. The microembossed features can cause a change in the intensity of the light reflected to the sensor. For example, the light source and sensor may move along the print medium and as the light source approaches a microembossed feature, the intensity of light reflected to the sensor may increase because the sloped surface of the medium reflects more light toward the sensor. The intensity of the light may then sharply drop when the light source passes over the microembossed feature, because more of the light is reflected away by the oppositely sloping surface of the medium after the microembossed feature. This can be read as a signal by the sensor. An area of the print medium that does not have a microembossed feature may not produce the same rise and drop in light intensity. This can be read as an absence of signal by the sensor. Microembossed features and unembossed areas can be arranged to form a code made of signal/no signal portions. As one example, this can encode binary data, with the signal and no signal portions corresponding to 1 and 0 values, respectively, in the binary code. Using such codes, individual unique types of print media can be labelled with a microembossed identification code that can be read by a printer having the appropriate sensor.

In further examples, the microembossed features can also be concave features, such as the depression in one face of the print medium instead of the bump or ridge formed on the opposite face of the print medium. Concave microembossed features can also be detected as a discontinuity in the intensity of light reflected off the surface of the print medium to the sensor.

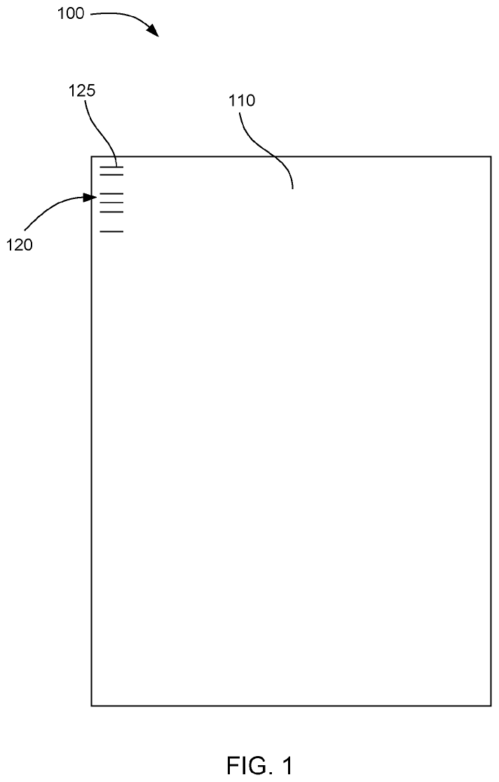

FIG. 1 shows a top view of an example print medium 100 in the form of a sheet having a print surface 110. A microembossed identification code 120 is applied to the print surface. The microembossed identification code includes multiple microembossed features 125 grouped together at a location on the print surface. In certain examples, the microembossed features can be microembossed linear ridges, as shown in FIG. 1. In other examples, the microembossed features can have other forms such as bumps, circles, or other shapes. In various examples, the microembossed features can be convex relative to the print surface. In other words, the microembossed features can be raised, protruding up from the print surface. In other examples, the microembossed features can be concave relative to the print surface, such as depressions in the print surface.

As used herein, “microembossed” refers to features that are small in size and that are either raised or indented into the print surface of the print medium. In some examples, microembossed features can be formed by pressing an object on one side of the print medium. This can create an impression or indentation on the side of the medium where the object has been pressed. A raised area can also be formed on the opposite side of the medium. In certain examples, microembossed features can be formed by an embossing roller or die. In one example, a paper print medium with microembossed identification codes can be made by rolling the paper between embossing rollers during the papermaking process. In further examples, microembossed features can be formed by other methods, such as removing a portion of the print medium to form a depression in the print surface.

In certain examples, the microembossed features can be sufficiently small in size to be not readily noticeable by the human eye. For example, the s microembossed features may be small enough that they are invisible to the human eye. In other examples, the microembossed features can be visible upon close inspection, but not noticeable under normal usage. In some particular examples, the microembossed features can have a feature height from 5 μm to 200 μm. As used herein, “feature height” refers to the distance between the normal print surface and the peak of a convex feature, or the bottom of a concave feature. For microembossed ridges, the feature height can be height of the ridges with respect to the normal print surface of the medium. In the case of concave indentations, the feature height can be depth of the indentations with respect to the normal print surface of the medium. In further examples, the feature height can be from 10 μm to 150 μm or from 20 μm to 100 μm.

In other examples, the microembossed features can be spaced a distance apart from adjacent microembossed features. In certain examples, the microembossed features can be spaced at from 20 μm to 1,000 μm relative to adjacent microembossed features. In further examples, the microembossed features can be spaced at from 50 μm to 500 μm relative to adjacent microembossed features.

In certain examples, the microembossed code can be placed in a location on the print surface that is relatively inconspicuous, such as near an edge or corner of the print surface. In some examples, the microembossed code can be within 1 cm of an edge of the print surface. In other examples, the microembossed code can be within 3 mm or within 1 mm of an edge of the print surface. In further examples, the microembossed code can be located in a margin of the print medium. In some cases a printer may be programmed not to print in the margin.

The microembossed identification codes can encode information about the print medium. In certain examples, the microembossed identification code can identify the type of print of medium. In other examples, the microembossed identification code can encode information about properties of the print medium, such as color, absorptivity, gloss level, and so on. In still further examples, the microembossed identification code can encode specific operating parameters to be used by a printer when printing on the print medium.

In some examples, the microembossed identification code can encode information as a binary code by including multiple microembossing locations that can contain either a microembossed feature or an unembossed location. Microembossed features can occupy a plurality of the microembossing locations, and a second plurality of microembossing locations can remain as unembossed locations. The microembossed features and unembossed locations can represent a binary code. For example, a microembossed feature can represent a “1” in the code, and an unembossed location can represent a “0” in the code. A microembossed identification code of this type can encode dozens or hundreds of individual types of print media with 6 or 7 microembossing locations. In some examples, the multiple microembossing locations can be equally spaced at a distance from 20 μm to 1,000 μm.

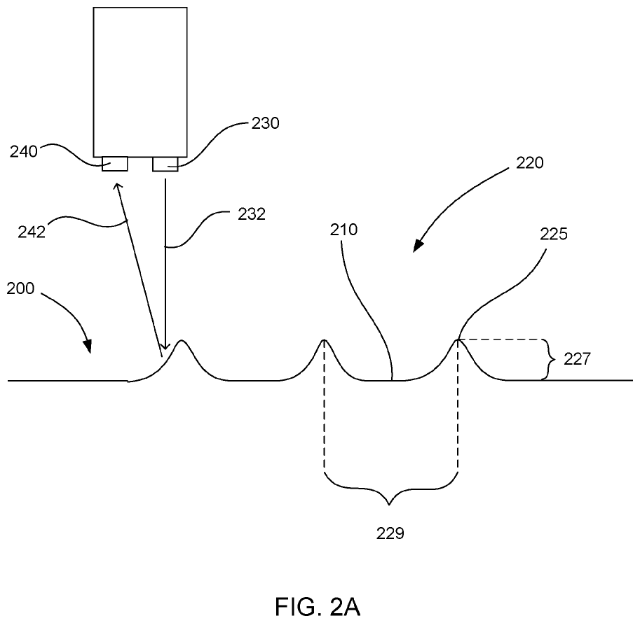

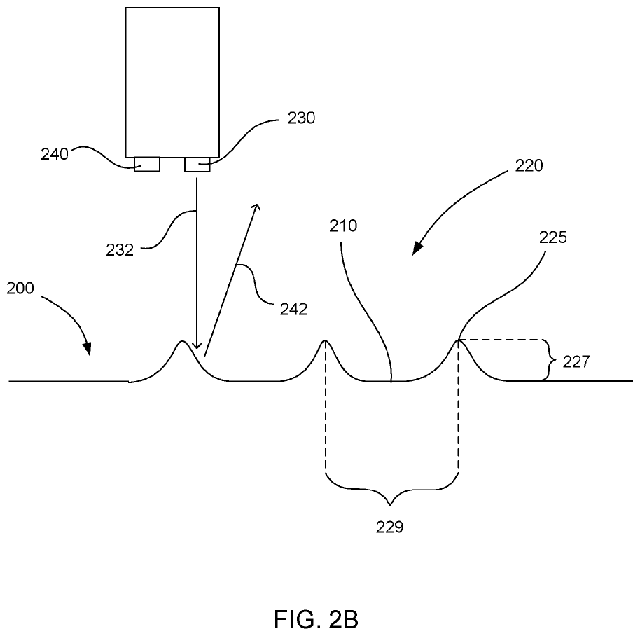

Features shown in FIGS. 2A and 2B can be described together, as they show several common features from common schematic perspective. Beginning initially with FIG. 2A, an edge view of a print medium 200 with a light source 230 and sensor 240 to read the microembossed identification code 220 on the print surface 210 of the print medium is shown. In this example, the microembossed features 225 that make up the microembossed identification code are linear ridges that are convex with respect to the print surface. FIG. 2A shows the measurement of the feature eight 227 and spacing 229 between the microembossed features. In this example, the sensor can read the microembossed identification code by measuring the intensity of light reflected back from the print surface. The light source can shine light, represented by arrow 232, toward the print surface at an incident angle. The changing slope of the print medium around the microembossed features can alter the incident angle of the light on the print surface, which can change the direction at which a majority of the light is reflected. Reflected light, represented by arrow 242, can be measured by the sensor. FIG. 2A shows the light source and the sensor in a position where a greater amount of light from the light source is reflected toward the sensor, due to the slope of the print medium at the microembossed feature.

FIG. 2B shows the same print medium 200 with the light source 230 and sensor 240 in a slightly different position with respect to the print medium. In this position, a greater amount of light from the light source, represented by arrow 232, is reflected away from the sensor, represented by arrow 242. In some examples, the light source and/or sensor can be moveable with respect to the print medium as shown in FIGS. 2A-2B. The sensor can detect the microembossed features by measuring an increase in reflected light intensity as the light source approaches the microembossed feature, as shown in FIG. 2A. The sensor can then detect a drop in reflected light intensity when the light source passes over the peak of the microembossed feature, as shown in FIG. 2B.

It is noted that the specific amount of light reflected by the print surface can be different depending on the type of print media. Additionally, the change in light intensity detected by the sensor can vary depending on the type of print media. For example, more glossy media can exhibit a more pronounced increase and decrease in reflected light intensity at the microembossed features because the glossy surface tends to reflect more light at a specific incident angle. Matte surfaces and rough surfaces may exhibit a less pronounced increased and decrease in reflected light intensity because the matte surface tends to scatter light. However, most print media will reflect a portion of the light from the light source at the incident angle, so that a change in light intensity can be detected at the microembossed feature. Furthermore, in some examples the microembossed feature can block a portion of light from reaching the sensor when the light source passes over the peak of the microembossed feature. This “shadow” cast by the microembossed feature can often result in a detectable drop in the light intensity measured by the sensor, regardless of the print media type.

Additionally, the sensor can often measure small variations in reflected light intensity even when the sensor and/or light source moves over blank, unembossed media. This “noise” can tend to be greater for media with rough or less-uniform surfaces. However, the height and spacing of the microembossed features making up the microembossed identification codes can be designed so that the measured light intensity can have a sufficient signal to noise ratio to allow for accurate reading of the codes. In some examples, this may call for larger microembossed features on rough media, while smaller s microembossed features may be sufficient for smoother media. In some cases, the microembossed features can have a feature height that is from 2 to 20 times greater than a roughness value of the print medium. For example, a print medium with a roughness of 5 μm may have microembossed features with a feature height of 10 μm to 100 μm. In further examples, the feature height can be from 4 to 10 times the roughness value of the print medium.

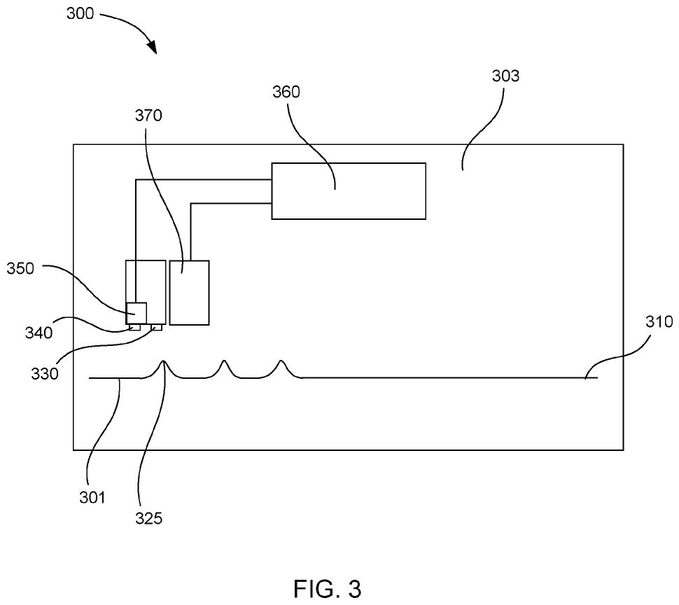

FIG. 3 shows a schematic of an example printing system 300 in accordance with an example of the present disclosure. The printing system includes a print medium 301 and a printer 303. The print medium can include a print surface 310 with microembossed features 325 on the print surface making up a microembossed identification code. It should be noted that the microembossed features are not drawn to scale in this figure. As explained above, the microembossed features can be sufficiently small that they are not easily noticeable by the human eye. The printer can include a light source 330 directed towards the print surface. An optical sensor 340 is spaced apart from the light source. The optical sensor can optically detect reflected discontinuities from the print surface introduced by the microembossed identification code. An electro-optical converter 350 can convert the optical information related to the reflected discontinuities into electrical signal. The electro-optical converter can be connected to a controller 360. The controller can receive the electrical signal from the electro-optical converter. The controller can then set an operating parameter of the printer based on the electrical signal. The example shown in FIG. 3 also includes an inkjet printhead 370 that can be used by the printer to print on the print surface of the print medium.

In various examples, printing systems can allow the light source and/or the optical sensor to be moveable with respect to the print medium. In some examples, the light source and optical sensor can be fixed with respect to the printer, but the printer can move the print medium past the light source and sensor using a feeding mechanism such as rollers. In other examples, the light source and/or sensor can be moveable with respect to the printer, so that the light source and/or sensor can move over different areas of the print medium even when the print medium is stationary. In certain examples, the light source or the optical sensor, but not both, may be fixed with respect to the print medium. In some such examples, microembossed identification codes can be read by moving the light source while the optical sensor remains stationary, or by moving the optical sensor while the light source remains stationary. In either of these cases, the changing angle of incidence of the light reflecting off the microembossed features can allow the optical sensor to detect the microembossed features. In still further examples, the light source and the optical sensor can move together with respect to the print medium. In certain examples, the light source and/or optical sensor can be mounted on a carriage together with a printhead so that the light source and/or optical sensor can move across the print surface in the same manner as the printhead.

In various examples, the microembossed codes can be read by the printer while the printer moves the print medium past the light source and optical sensor. In some such examples, the microembossed identification codes may be located along a side edge of the print medium, so that the codes move past the light source and the optical sensor as the print medium moves in the printer. In other examples, the codes can be located along a top or bottom edge of the print medium. In other examples, the light source and optical sensor can be mounted on a carriage with a printhead. The carriage can move the light source and sensor across the print medium from side to side. In some such examples, the microembossed identification code can again be located along a side edge or a top or bottom edge of the print medium. The microembossed features making up the microembossed identification codes can be oriented in a direction that allows the features to be read by the optical sensor. In some examples, the microembossed features can be ridges that are oriented perpendicular to the direction in which the optical sensor and/or light source moves. This orientation can allow for the changing intensity of light reflected from the microembossed features so that the optical sensor can read the microembossed identification code. In further examples, a print medium can include two microembossed identification codes oriented at a right angle with respect one to another, to accommodate for different printers that may move the optical sensor and light source in a different direction than other printers. In another example, microembossed ridges can be oriented diagonally so that a signal can be produced no matter which direction the optical sensor and light source move over the microembossed identification code.

In certain examples, the light source can include a visible light emitting diode, an infrared light emitting diode, a laser, a fluorescent bulb, and incandescent bulb, or a combination thereof. Generally, any light source capable of shining light at the print medium surface can be used. In further examples, the optical sensor can include a phototransistor, a photodiode, a CMOS sensor, or a combination thereof. In some cases, the electro-optical converter can be an integral part of the optical sensor, such as a phototransistor that provides a voltage proportional to the intensity of light hitting the phototransistor.

The controller can be programmed to receive electrical signals from the electro-optical converter. The controller can decode the microembossed identification code using the electrical signals. In some examples, the microembossed identification code can encode the type of print medium. The controller can decode the code to identify the print medium. The controller can then select appropriate operating parameters for the particular print medium. In certain examples, the controller can be in communication with a local memory with a stored list of print medium types and operating parameters for the print medium types. The controller can then access the local memory to determine the optimal operating parameters for printing on the print medium. In other examples, the controller can contact a server or another computer to access a list of print medium types and operating parameters.

In further examples, the microembossed identification code can encode information about properties of the print medium. For example, the microembossed identification code can include information about the porosity, gloss level, and so on of the print medium. The controller can then determine optimal operating parameters for printing on a print medium having those properties.

In still further examples, the microembossed identification code can encode the operating parameters suitable for printing on the specific print medium. In such examples, the controller can decode the microembossed identification code, and then simply use the operating parameters encoded in the microembossed identification code.

Although the print medium has been referred to above primarily as being in the form of sheets, other types of print media can also be used. Many types of print media can be in the form of sheets, such as office paper, photo paper, transparencies, and so on. In some such examples, each sheet can include a microembossed identification code so that printers can identify the media type. In other examples, the microembossed identification code can be applied to another part of the print medium, such as to a box or package that holds a number of sheets of the print medium. The microembossed identification code can be read by the printer when the print medium is loaded into the printer. In further examples, the print medium can be in the form of a roll or web. This can include a long, continuous length of the print medium that is fed through a printer. In such examples, the microembossed identification codes can be applied to the print medium roll. For example, a microembossed identification code may be applied along an edge of the print medium so that the code can be read as the print medium is fed through the printer. The can be repeated continuously along the edge or at regular intervals. In other examples, the microembossed identification code can be applied to a core of the print medium roll, such as a cardboard tube around which the print medium has been rolled.

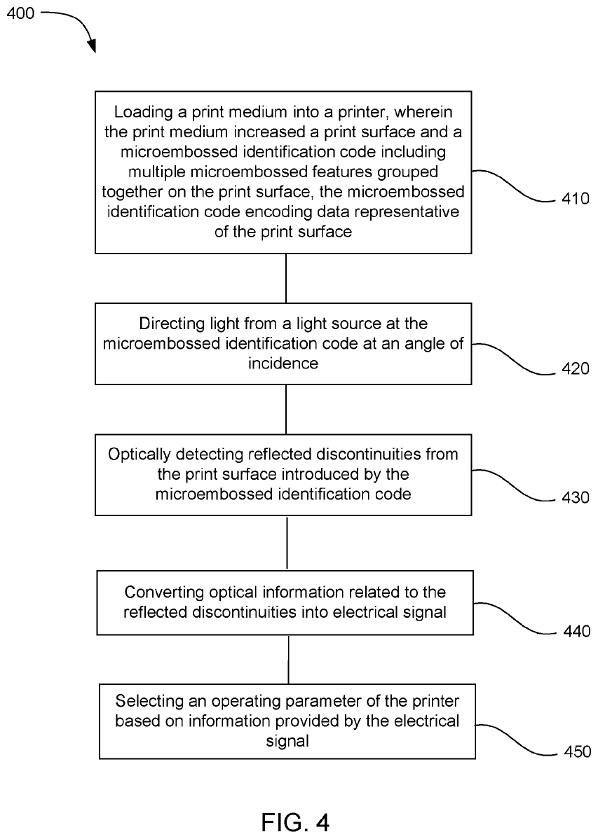

FIG. 4 shows a flowchart of a method 400 of establishing a printer operating parameter. The method can include loading 410 a print medium into a printer, wherein the print medium increased a print surface and a microembossed identification code including multiple microembossed features grouped together on the print surface, the microembossed identification code encoding data representative of the print surface. The method can further include directing 420 light from a light source at the microembossed identification code at an angle of incidence, and optically detecting 430 reflected discontinuities from the print surface introduced by the microembossed identification code. Additional steps can include converting 440 optical information related to the reflected discontinuities into electrical signal, and selecting 450 an operating parameter of the printer based on information provided by the electrical signal. The operating parameter can be related to a printing characteristic of the print surface. In some examples, the operating parameter that is selected can be a color map, which can involve mixing multiple colors of ink when printing to achieve a particular color appearance in the printed image. In other examples, the operating parameter can include ink volume printed in a unit area, such as in a square centimeter. Some types of media can produce a clearer image with less ink, while other types of media may produce a better image with more ink. In still further examples, the operating parameter can involve drying time, as different media types having different absorptivities may benefit from different drying times. In some examples, the print speed can be adjusted to control the drying time, with slower print speed affording more drying time.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and can be determined based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Dimensions, ratios, and other numerical data may be presented herein in a range format. It is to be understood that such range format is used merely for convenience and brevity and should be interpreted flexibly to include the numerical values explicitly recited as the limits of the range, and also to s include all the individual numerical values or sub-ranges encompassed within that range as if each numerical value and sub-range is explicitly recited. For example, a dimension range of 5 μm to 200 μm should be interpreted to include the explicitly recited limits of 5 μm and 200 μm, and also to include individual dimensions such as 10 μm, 50 μm, 100 μm, 150 μm, etc., and sub-ranges such as 5 μm to 50 μm, 50 μm to 200 μm, 20 μm to 150 μm, etc.

In the present disclosure, it is noted that when discussing the print media, methods, and systems described herein, each of these discussions can be considered applicable to each of these examples, whether or not they are explicitly discussed in the context of that example. Thus, for example, in discussing details about the print media, such discussion also refers to the methods and systems, and vice versa.

### EXAMPLES

### Example 1

Six different sheets of paper were microembossed with a microembossed feature in the form of a linear ridge that was convex on the print surface of the paper. The six sheets included two sheets of HP Brochure Paper, two sheets of HP Advanced Photo (AP) paper, and two sheets of HP Multipurpose (MP) paper. The paper was placed in a test device for testing the ability of a “Zim” sensor to detect the microembossed feature. The Zim sensor includes a LED light source and a photo transistor receiver. These sensors have been used in printers for detecting the edge of paper and for measuring the location of black and colored dots for printer alignment.

The light source and photo transistor receiver were placed at a distance of 5 mm above the surface of the paper. The light source was an LED powered at 3.2 V with a current of 6.4 mA. The microembossed features were made by hand by pressing a ball point pen into the reverse side of the paper.

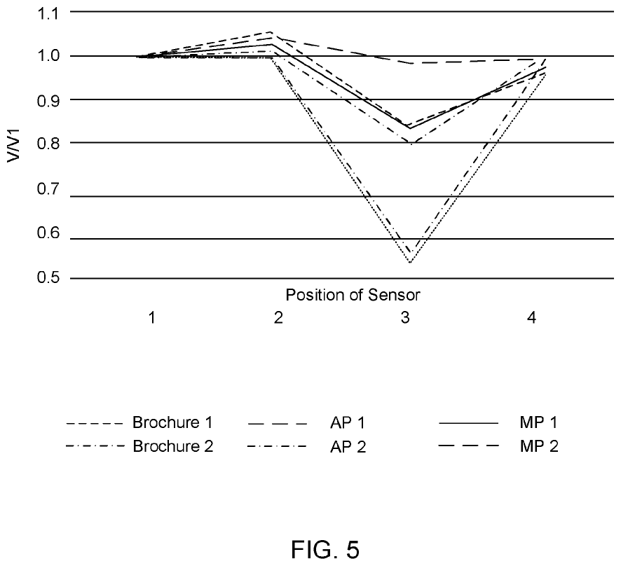

FIG. 5 is a graph showing the voltage change read by the photo transistor receiver as the sensor moves over a microembossed feature on the sheets of paper. The y-axis shows the voltage reading divided by the normal voltage reading when the sensor is over a flat, unembossed portion of the paper. The x-axis represents locations of the sensor moving over the microembossed feature. The numeral 1 on the x-axis is a location on a flat portion of the paper before the microembossed feature is reached by the sensor. Position 2 is at the beginning of the slope up of the microembossed feature. Position 3 is on the opposite slope of the microembossed feature, after the light source passes the peak of the microembossed feature. Position 4 is the end of the slope after the microembossed feature. More specifically, the numbered positions are the locations of the light source shining onto the paper surface. Thus, when the light source passes the peak of the microembossed feature (between position 2 and position 3), the voltage reading of the sensor drops sharply because the light is reflected away from the sensor on the opposite slope of the microembossed feature. As can be seen, each of the six types of media measured a drop in current when the light source went over the peak of the microembossed feature.

### Example 2

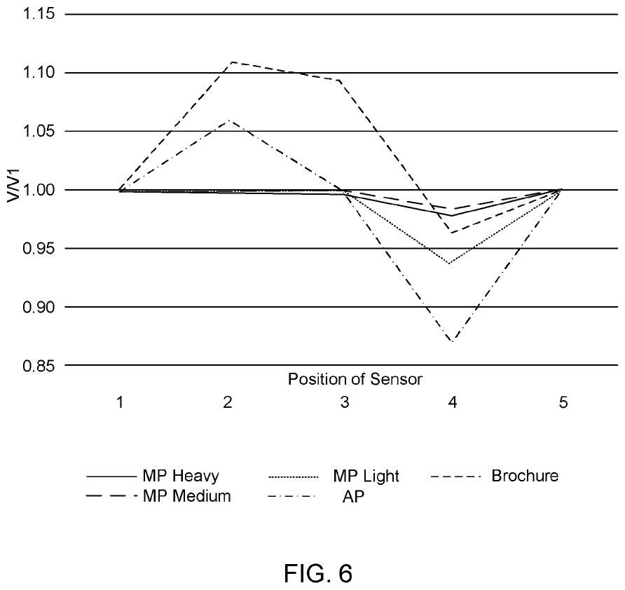

Another experiment was conducted similar to Example 1, but the voltage from the photo transistor receiver was measured at five points. Point 1 was before the slope of the microembossed feature; point 2 was on the upward slope of the microembossed feature; point 3 was when the light source was directly over the peak of the microembossed feature; point 4 was on the downward slop after the peak; and point 5 was flat paper after the downward slope. Microembossed features were measured on HP Advanced Photo (AP) paper and HP Brochure Paper, and three microembossed features of varying feature height (made by heavy, medium, and light embossing) were measured on a sheet of HP Multipurpose (MP) paper. The voltages were measured as the sensor was moved across the print surface of the print medium. FIG. 6 shows a graph of the voltage divided by the normal voltage over a flat portion of the paper. The media types showed a drop in voltage when the light source moved past the microembossed feature.

While the disclosure has been described with reference to certain examples, various modifications, changes, omissions, and substitutions can be made without departing from the spirit of the disclosure. It is intended, therefore, that the disclosure be limited by the scope of the following claims.

What is claimed is:

1. A print medium, comprising:
a print surface; and
a microembossed identification code applied to the print surface, the microembossed identification code comprising multiple microembossed features grouped together at a location on the print surface, wherein the microembossed features have a feature height from 5 μm to 200 μm and are spaced relative to adjacent microembossed features at from 20 μm to 1,000 μm.

2. The print medium of claim 1, wherein the location is within 1 cm of an edge of the print medium.

3. The print medium of claim 1, wherein the print medium includes multiple microembossing locations, wherein a microembossed feature occupies a first plurality of the multiple microembossing locations and a second plurality of the multiple microembossing locations remain as unembossed locations, wherein microembossed features and unembossed locations represent a binary code.

4. The print medium of claim 3, wherein the multiple microembossing locations are equally spaced locations.

5. The print medium of claim 1, wherein the microembossed features comprise microembossed linear ridges.

6. The print medium of claim 1, wherein the microembossed features are convex relative to the print surface.

7. A printing system, comprising:
a print medium, comprising:
a print surface, and
a microembossed identification code on the print surface, the microembossed identification code comprising multiple microembossed features grouped together at a location on the print surface;
a printer, comprising:
a light source directable or directed towards the print medium at an angle of incidence when loaded in the printer;
an optical sensor spaced apart from the light source to optically detect reflected discontinuities from the print surface introduced by the microembossed identification code;
an electro-optical converter to convert optical information related to the reflected discontinuities into electrical signal; and
a controller to receive the electrical signal and to set an operating parameter of the printer based on the electrical signal.

8. The printing system of claim 7, wherein the microembossed features have a feature height from 5 μm to 200 μm and are spaced relative to adjacent microembossed features at from 20 μm to 1,000 μm.

9. The printing system of claim 7, wherein the light source, the sensor, or both are moveable with respect to the print medium.

10. The printing system of claim 7, wherein the controller decodes the microembossed identification code on the print surface and selects the operating parameter based on the decoded microembossed identification code.

11. The printing system of claim 7, wherein the operating parameter comprises a blending ratio of multiple ink colors, a volume of ink printed per area of print medium, a printing speed, or a combination thereof.

12. The printing system of claim 7, wherein the light source comprises a visible light emitting diode, an infrared light emitting diode, a laser, a fluorescent bulb, an incandescent bulb, or a combination thereof.

13. The printing system of claim 7, wherein the optical sensor comprises a phototransistor, a photodiode, a CMOS sensor, or a combination thereof.

14. A method of establishing a printer operating parameter, comprising:
loading a print medium into a printer, wherein the print medium comprises a print surface and a microembossed identification code including multiple microembossed features grouped together on the print surface, the microembossed identification code encoding data representative of the print surface;
directing light from a light source at the microembossed identification code at an angle of incidence;
optically detecting reflected discontinuities from the print surface introduced by the microembossed identification code;
converting optical information related to the reflected discontinuities into electrical signal; and
selecting an operating parameter of the printer based on information provided by the electrical signal.

15. The method of claim 14, wherein the operating parameter is related to a printing characteristic of the print surface.
